(19) United States
(12) Patent Application Publication
(10) Pub. No.: US 2010/0269652 A1
(43) Pub. Date: Oct. 28, 2010

(54) APPARATUS AND METHOD OF PERFORATING A COMPONENT

(75) Inventor: KARSTEN BECKER, Rodinghausen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Maschinenbau GmbH, Bielefeld (DE)

(21) Appl. No.: 12/763,685

(22) Filed: Apr. 20, 2010

(30) Foreign Application Priority Data
Apr. 21, 2009 (DE) 10 2009 017 972.0

(51) Int. Cl. B26F 1/00; B26D 5/08

(52) U.S. Cl. 83/30; 83/523; 83/549

(57) ABSTRACT

Apparatus for perforating a component includes at least one robotic arm having a free end for securement of an adapter. At least one hole punch is coupled by the adapter to the robotic arm. The adapter can be configured in one of two ways, a first way in which the adapter supports a component gripper in addition to the hole punch, a second way in which the adapter supports a further hole punch in addition to the one hole punch.

### CROSS-REFERENCES TO RELATED APPLICATIONS

This application claims the priority of German Patent Application, Serial No. 10 2009 017 972.0, filed Apr. 21, 2009, pursuant to 35 U.S.C. 119(a)-(d), the content of which is incorporated herein by reference in its entirety as if fully set forth herein.

### BACKGROUND OF THE INVENTION

The present invention relates, in general, to an apparatus and method of perforating a component.

The following discussion of related art is provided to assist the reader in understanding the advantages of the invention, and is not to be construed as an admission that this related art is prior art to this invention.

Shear cutting has been used to punch one or more holes in a workpiece. The punching process typically is executed on a stationary punching machine to which the workpiece to be machined is fed. Such a punching machine requires much space and is inflexible because the stroke direction is predefined.

It would therefore be desirable and advantageous to address these prior art problems and to obviate other prior art shortcomings.

### SUMMARY OF THE INVENTION

According to one aspect of the present invention, an apparatus for perforating a component includes at least one robotic arm having a free end, at least one hole punch, and an adapter arranged on the free end of the robotic arm and coupling the at least one hole punch to the robotic arm, wherein the adapter is configured in one of two ways, a first way in which the adapter supports a component gripper in addition to the hole punch, a second way in which the adapter supports a further hole punch in addition to the one hole punch.

According to another advantageous feature of the present invention, the hole punch may be configured to include exchangeable punching tools for producing holes in the component. These punching tools may be exchanged automatically, for example via a quick change system. In this way, the desired hole size can be quickly and automatically realized.

A selective attachment of a component gripper or further hole punch to the adapter renders the apparatus versatile. For example, the disposition of a second hole punch permits for example to handle a component with punching tools of different sizes, without requiring complete detachment of a hole punch from the adapter and replacement by another hole punch, when the hole size is to be changed.

According to another advantageous feature of the present invention, the robotic arm may be program-controlled. The motions of the robotic arm and thus the disposition of the holes in the component may be controlled by a control unit, for example a computer, or manually through remote control. In addition, the control unit can be used to control the exchange of punching tools.

As the free end of the robotic arm is able to swing about several axes, it is possible to perforate the component with holes in different spatial planes. This has the benefit that even complex three-dimensional components can easily be perforated.

Some sections of the robotic arm can be supported for swinging or rotating about a vertical axis and a horizontal axis. As a result, additional degrees of freedom for the motion of the hole punch can be established.

According to another advantageous feature of the present invention, the hole punch may include a hydraulic drive. Suitably, the hole punch is configured as pantographic hole punch. Optionally, the hole punch may include a hydraulic stripping device for the component in addition to the particular punching tool that is suited to the holes to be produced.

Of course, it is also conceivable to use a first robotic arm with one or two hole punches and a further robotic arm with a component gripper. The use of a component gripper allows an automated exchange of a component or workpiece. In principle, there is also the option to exchange components by hand.

According to another aspect of the present invention, a method of perforating a component includes the steps of mounting at least one hole punch to a robotic arm, perforating the component by the at least one hole punch, and moving the at least one hole punch in relation to the component into an operating position in dependence on the position of a perforation.

After perforating, the component may be removed from the punching tool by a stripping device. The hole punch can be moved in such a way that the punching tool reaches the next position that the component is to be holed as rapidly as possible.

According to another advantageous feature of the present invention, the component can be held by at least one component gripper that is secured to the robotic arm.

Loading of a clamping device with a workpiece can occur by hand through an operator or also automatically for subsequent perforation by a hole punch. Suitably, the clamping device is loaded automatically by means of a second robotic arm in order to shorten the cycle times for processing the component, including loading and unloading, compared to cycle times during manual loading.

The use of a robotic arm for perforating components is also advantageous because of the attained flexibility of the apparatus. For example, adapters can be exchanged so that the robotic arm can be easily retrofitted for other manipulations in addition to punching holes. Depending on need, various processing steps can be executed in one station.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of one exemplary embodiment of an apparatus for perforating a component in accordance with the present invention, including a robot system with a robotic arm;

FIG. 2 is a schematic illustration of another exemplary embodiment of an apparatus for perforating a component in accordance with the present invention, including a robot system with two robotic arms;

FIG. 3 is a cross section of an exemplary hole punch; and

FIG. 4 is a perspective illustration of the hole punch of FIG. 3.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

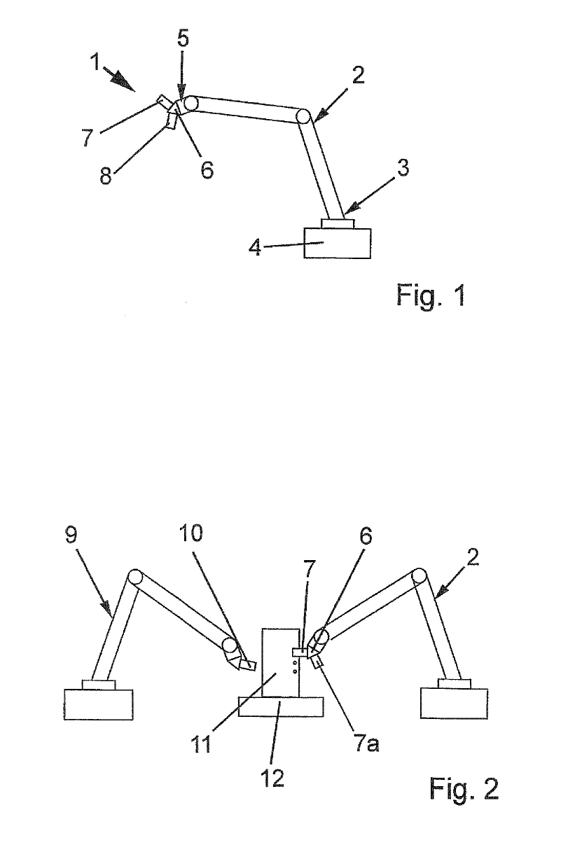

Turning now to the drawing, and in particular to FIG. 1, there is shown a schematic illustration of an apparatus, generally designated by reference numeral 1, for perforating a component, also referred to as workpiece. The apparatus 1 includes a robot system having a robotic arm 2. It will be appreciated by persons skilled in the art that the robot system must contain further elements which do not appear in the drawings for the sake of simplicity, e.g. a control unit or other mechanical devices.

The robotic arm 2 has one end 3 which is anchored in a mount 4, and another free mobile end 5 which supports an adapter 6 for receiving at least one hole punch 7. In the non-limiting example of FIG. 1, the adapter 6 supports in addition to the hole punch 7 a component gripper 8 to transport a component, e.g. a sheet metal part, to a clamping device. The clamped component is then perforated by the hole punch 7. Further holes may be produced in one and the same clamping device by having the robotic arm 2 move to further positions on the workpiece.

FIG. 2 shows another embodiment in which the apparatus has two robotic arms 2, 9. The robotic arm 2 is hereby provided with one or more hole punches 7, 7a which are secured to the adapter 6, whereas the other robotic arm 9 is provided with a component gripper 10 for example. The component gripper 10 is provided for transport of the component to a clamping device 12 and for exchange of components 11. It is theoretically also conceivable to have the component gripper 10 hold a component 11 to be perforated in relation to the hole punch 7 of the robotic arm 2. In general, the hole punch 7 operates program-controlled.

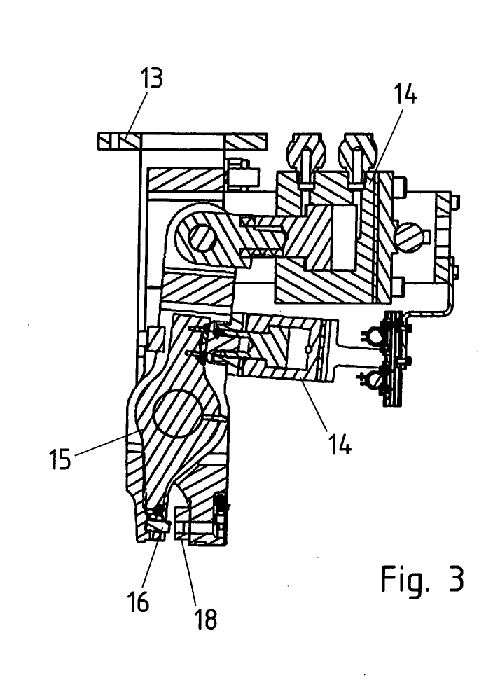

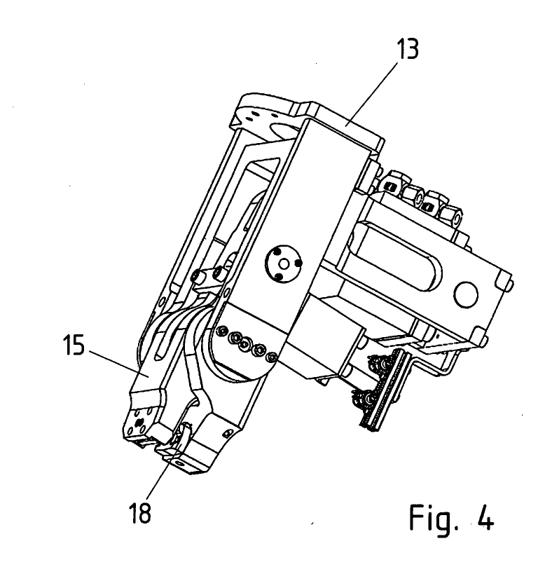

Turning now to FIGS. 3 and 4, there are shown a cross section and a perspective illustration, respectively, of an exemplary embodiment of a hole punch 7 for use in the apparatus 1. The hole punch 7 is configured as pantographic hole punch and has a frame 13 to support a hydraulic drive in the form of two hydraulic piston and cylinder units 14 in spaced-apart disposition to act on a lever assembly 15. The lever assembly 15 has a free end for supporting a punching tool 16 which cooperates with a stationary jaw 17 to perforate an unillustrated component. The jaw 17 includes a holed platform 18 to complement the configuration of the punching tool 16. Operation of the hydraulic drive moves the lever assembly 14 to an away from the jaw 16. Punching tool 16 and platform 18 are exchangeable to suit the situation at hand.

An apparatus according to the present invention is able to provide even complex three-dimensional components with holes or openings that otherwise cannot be processed on a stationary punching machine.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for perforating a component, comprising:
at least one robotic arm having a free end;
at least one hole punch; and
an adapter arranged on the free end of the robotic arm and coupling the at least one hole punch to the robotic arm, said adapter being configured in one of two ways, a first way in which the adapter supports a component gripper in addition to the hole punch, a second way in which the adapter supports a further hole punch in addition to the one hole punch.

2. The apparatus of claim 1, wherein the robotic arm is program-controlled.

3. The apparatus of claim 1, wherein the at least one hole punch includes a hydraulic drive.

4. The apparatus of claim 1, wherein the at least one hole punch is configured as pantographic hole punch.

5. The apparatus of claim 1, wherein the at least one hole punch is configured to include exchangeable punching tools.

6. A method of perforating a component, comprising the steps of:
mounting at least one hole punch to a robotic arm;
perforating the component by the at least one hole punch; and
moving the at least one hole punch in relation to the component into an operating position in dependence on the position of a perforation.

7. The method of claim 6, further comprising the step of holding the component by at least one component gripper that is secured to the robotic arm.

8. The method of claim 6, further comprising the step of stripping the component after the perforating step from a punching tool of the at least one hole punch.

9. The method of claim 8, wherein the stripping step is carried out hydraulically.
